(19) United States
(12) Patent Application Publication
(10) Pub. No.: US 2010/0215195 A1
(43) Pub. Date: Aug. 26, 2010

(54) DEVICE FOR AND A METHOD OF PROCESSING AUDIO DATA

(75) Inventors: Aki Sakari Harma, Eindhoven (NL); Steven Leonardus Josephus Dimphina Elisabeth Van De Par, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/600,041

(22) PCT Filed: May 21, 2008
(86) PCT No.: PCT/IB08/51998

§ 371 Date: Nov. 13, 2009

(30) Foreign Application Priority Data
May 22, 2007 (EP) 07108601.1

(51) Int. Cl. H04B 1/00; G06F 17/00

(52) U.S. Cl. 381/119; 704/503

(57) ABSTRACT

According to an exemplary embodiment of the invention, a device (100) for processing audio data (101, 102) is provided, wherein the device (100) comprises a manipulation unit (103) (particularly a resampling unit) adapted for manipulating (particularly for resampling) selectively a transition portion of a first audio item (104) in a manner that a time-related audio property of the transition portion is modified (particularly, it is possible to simulate also the temporal delay effects of movement in a realistic manner).

### FIELD OF THE INVENTION

The invention relates to a device for processing audio data.

Beyond this, the invention relates to a method of processing audio data.

Moreover, the invention relates to a program element.

Furthermore, the invention relates to a computer-readable medium.

### BACKGROUND OF THE INVENTION

Audio playback devices become more and more important. Particularly, an increasing number of users buy headphone-based audio players and loudspeaker-based audio surround systems.

When different audio items are played back by an audio player one after another, it is desirable to have an apparently seamless transition between two subsequent tracks. This may be denoted as “mixing”. During a “cross-fade”, it is possible to cross fade the tracks during the transition phase from one track to another. In an automated system, in order to provide a seamless transition between tracks, amplification of the outgoing track will typically be reduced at the same rate as the amplification of the incoming track is increased.

Methods are known allowing for automatic playback of songs including mixing and cross-fading to get a smooth transition between successive songs. Such techniques may be denoted as auto DJ. When a play list is provided, it is not per definition possible to play all songs within the play list such that, during a transition, the subjective perception of the audio quality is proper.

A conventional auto DJ system allows to perform a cross-fade blindly allowing the clashing of the tempo and the harmony. This may give a perceptually unpleasant (“bad DJ”) experience. In case of a play list defined by a normal user, the occurrence of unmatched transitions is even larger than in a play list composed by a professional disc jockey.

Another conventional system is based on the rule that a brief break is left between two play back items such that mixing of the harmony does not occur, and the continuity of the tempo is broken. That is, the sound is muted. This approach efficiently makes the two playback list items temporally separated, and if the pause is sufficiently long, there is no experience of the discontinuity of the rhythm or the harmony. Any auto DJ effect is obviously absent in such a concept.

What users commonly do when listen to an audio play list, record or other music collection is to jump from one item forward to another item, or backward, for instance by pressing a “next”, or “previous” button on the player, respectively. This may be performed anywhere between the start and the end of the audio item. The way in which this is implemented in audio players is that the current item is muted and the new track starts playing.

More sophisticated ways of moving from one audio track to another is an auto DJ system aiming at mixing two tracks in such a way that moving from one track to another is performed similarly to how a dance music disc jockey would integrate the end of one item to the beginning of another. The two signals may be synchronized and the signals gradually cross-faded to give an impression of a smooth transition from one item to another.

US 2005/0047614 A1 discloses a system and a method for enhancing song-to-song transitions in a multi-channel audio environment such as a surround environment. In the method, by independently manipulating the volumes of the various channels of each program during transitions, an illusion of motion is imparted to the program which is ending to create an impression that the song is exiting while motion is imparted to the program which is starting to create an impression that the song is entering.

However, a transition between two audio pieces according to US 2005/0047614 A1 may still sound artificial for a human listener because movement is simulated in a simplistic way.

### OBJECT AND SUMMARY OF THE INVENTION

It is an object of the invention to provide an audio system allowing for a proper audio experience at the beginning or end of an audio item.

In order to achieve the object defined above, a device for processing audio data, a method of processing audio data, a program element and a computer-readable medium according to the independent claims are provided. Advantageous embodiments are defined in the dependent claims.

According to an exemplary embodiment of the invention, a device for processing audio data is provided, wherein the device comprises a manipulation unit (particularly a resampling unit) adapted for manipulating (particularly for resampling) selectively a transition portion of a first audio item of the audio data in a manner that a time-related audio property of the transition portion is modified (particularly, it is possible to simulate also the temporal delay effects of movement in a realistic manner).

According to another exemplary embodiment of the invention, a method of processing audio data is provided, wherein the method comprises selectively manipulating a transition portion of a first audio item of the audio data in a manner that a time-related audio property of the transition portion is modified.

According to still another exemplary embodiment of the invention, a program element (for instance a software routine, in source code or in executable code) is provided, which, when being executed by a processor, is adapted to control or carry out a data processing method having the above mentioned features.

According to yet another exemplary embodiment of the invention, a computer-readable medium (for instance a CD, a DVD, a USB stick, a floppy disk or a harddisk) is provided, in which a computer program is stored which, when being executed by a processor, is adapted to control or carry out a data processing method having the above mentioned features.

Data processing for audio tempo manipulation and/or frequency alteration purposes which may be performed according to embodiments of the invention can be realized by a computer program, that is by software, or by using one or more special electronic optimization circuits, that is in hardware, or in hybrid form, that is by means of software components and hardware components.

In the context of this application, the term “manipulating” may particularly denote a recalculation of a specific portion of an audio data stream or of an audio data piece to selectively modify temporal or frequency-related properties of this portion, that is parameters having an influence on the audible experience regarding a tempo and pitch of a sound reproduction. Thus, properties such as tempo and/or pitch may be modified by such a manipulation, particularly to obtain a Doppler effect. Thus, the manipulation or resampling may be performed by recalculating samples in a sound file with different properties than in the originally recorded file. This may include removing samples, modifying an available frequency range, introducing pauses, increasing or reducing reproduction times of a tone, etc., in a manner to improve the perception of a transition between audio pieces. Specifically, because the pitch transition effects that allow for a perceptual decoupling of the ending and starting track may avoid tempo and harmonic clashes between the subsequent audio pieces.

The term “transition portion” of an audio item may particularly denote a beginning portion and/or an end portion of the audio item at which a transition occurs between the audio item and another (preceding or succeeding) audio item or between the audio item and a silent time interval.

The term “time-related audio property” may particularly denote that the time characteristics and the corresponding audio parameters may be adjusted in a specific manner, for instance to stress the impression of a fading in or fading out audio piece. This may include a frequency change which is known as the so-called acoustic Doppler effect, and which is an intuitive measure for indicating fading in or fading out of an audio item.

According to an exemplary embodiment of the invention, a transition portion of an audio piece is selectively processed to improve the perception, for a human ear, of a transition between the audio item and previous or subsequent audio information. By changing time related audio playback properties during fade-in and/or fade-out, the impression of an approaching or departing sound source may be generated, which may be correlated psychologically as the start of a new song or the end of a presently played back song, respectively.

Thus, according to an exemplary embodiment, dynamic mixing for automatic DEng may be made possible. In automatic disc jockey systems, song transitions may be made such that no disturbing discontinuities arise. This may be generally done by cross-fading two consecutive songs. A requirement in order to get a smooth transition is that the tempo and rhythm of the songs are aligned in the mixing region and that the songs have harmonic properties that match in the mixing region. This conventionally puts constraints on the songs that can be played after another. According to an exemplary embodiment, the need to align a tempo, rhythm and harmony may be overcome by applying a different gliding change in the sampling frequency to each song during the transition. The gliding sampling frequencies may create a natural decoupling of the two songs that are mixed such that tempo, rhythm and harmonic clashes do not matter. Thus, embodiments of the invention may overcome the limitation that not every play list (or pair of songs) can be cross-faded with an auto DJ method. A recognition on which embodiments of the invention are based is that there are also other possible ways of making two play list items perceptually separated than the temporal separation by a pause. For this purpose, it is possible to use the dynamic systematic manipulation of spectra of one or two audio signals. In particular, it is possible to perform a method wherein in the mixing region of the song, a manipulation/resampling of the songs is performed such that one song has a frequency and tempo that is gliding down while the other has a tempo and frequency that is gliding up. Thus, a temporal manipulation of audio items in forced transitions and auto DJ applications may be used and may be based on the consideration that a sufficiently strong Doppler shift effect may be induced which causes the frequency gliding effect. Thus, a dynamic mixing for automatic DJ applications may be made possible. A natural decoupling of two songs that are mixed in an auto DJ system may be made possible such that the songs need not to be similar in tempo, rhythm, harmonic content, etc. This may be created by manipulating the two songs in the transition period such that the tempo and/or frequency of the song that is ending is gliding down from the original frequency to a lower frequency, and that the tempo and/or frequency of the song that is starting is gliding down towards the original frequency with a different frequency contour. This can also be achieved as a by-product of a spatial transition effect. An illusion of movement of the virtual sources of the two songs may be created, and a Doppler effect may be generated. Depending on the method to create the illusion of the movement of the source, this may also often produce the Doppler effect, that is the Doppler effect is a consequence of the movement effect.

Next, further exemplary embodiments of the device for processing audio data will be explained. However, these embodiments also apply to the method of processing audio data, to the program element and to the computer-readable medium.

The transition portion of the first audio item may be an end portion of the first audio item. In other words, the manipulating may be performed to fade out an end of the first audio item smoothly, by adjusting the time property in a gradual or stepwise manner.

Additionally or alternatively, the transition portion of the first audio item may be a beginning portion of the first audio item. In other words, the manipulating may be performed to fade in a beginning of the first audio item smoothly, by adjusting the time property in a gradual or stepwise manner. Thus, it is possible to manipulate only a beginning portion of an audio item, only an end portion of an audio item, or both a beginning portion and an end portion of an audio item. It is also possible that a middle portion of an audio item is manipulated in such a manner, for instance, a user may stop the playback in the middle of a first song, and start to play a second song from its beginning or from somewhere in the middle of the second song. In other words, a natural beginning or a natural end of an audio item may or may not coincide/fall together with the transition portion. Selective temporal manipulation according to exemplary embodiments of the invention may therefore be also performed in the middle of a song.

Particularly, the manipulation unit may be adapted for manipulating the end portion of the first audio item in a manner that at least one of the group consisting of a tempo and a frequency of the manipulated end portion of the first audio item is gliding out. Thus, by considering such time-related audio parameters which have an influence on the audio perception when playing back such audio content, it may be possible to obtain the impression of an acoustic Doppler effect, as known from a departing horn of an ambulance, which is not only decrease in amplitude, but also in frequency (It should be noted that the frequency of the sound of the departing ambulance horn is lower than the sound of an approaching ambulance, but it is not decreasing (gliding) in frequency unless the ambulance is accelerating or slowing down the speed in respect to the observer). Particularly, the tempo and/or the frequency may be reduced when an end portion of a fading out audio item is manipulated.

Although embodiments of the invention may focus on providing smooth transitions between successively reproduced audio items, it is possible to process only exactly one audio item, for instance an audio item which shall be muted softly in an end portion.

However, the manipulation unit may also be adapted for manipulating a transition portion of a second audio item (which may succeed the first audio item) in a manner that a time-related audio property of the transition portion is modified. Thus, a transition between the first audio item and the second audio item may be made smooth by considering the time-related audio properties in both transition portions. During the transition portion(s), both the first and the second audio items may be played back simultaneously, however, with different audio parameters.

Particularly, the transition portion of the second audio item may be a beginning portion of the second audio item. The manipulation unit may then be adapted for manipulating the beginning portion of the second audio item in a manner that at least one of the group consisting of a tempo and a frequency of the manipulated beginning portion of the second audio item is gliding in/faded in. For such a fade in effect, it may be appropriate to increase tempo and frequency (in a gradual or stepwise manner) until the transition portion of the second audio item has been completed.

The manipulation unit may be adapted for manipulating selectively only the transition portion (beginning portion or end portion) or transition portions (beginning portion and end portion) of the first audio item, whereas a remaining (central) portion of the first audio item may remain unsampled, that is to say unaltered. Therefore, after having smoothly faded in the audio signal to be subsequently played back, the original data may be replayed so that no audio artefacts occur after completion of the transition regime.

The manipulation unit may be adapted for manipulating the transition portion of the first audio item and the transition portion of the second audio item in a coordinated manner. Therefore, the decrease of the tempo and frequency of the faded out item (causing a Doppler effect of a departing audio source) may be combined in a harmonized manner with the fading in of a subsequent audio signal in which tempo and frequency are increased (Doppler effect of an approaching audio source). This may allow for an acoustically appropriate transition portion even between audio content of very different origin so that the two songs to be mixed do not necessarily have to correspond to one another regarding tempo, rhythm or harmonic clashes.

The manipulation unit may also serve as a motion experience generation unit adapted for processing the first audio item in a manner to generate an audible experience that an audio source reproducing the first audio item is moving during the transition portion. However, such an impression of a moving audio source does not necessarily be limited to the simple variation of a loudness of the audio item (increasing loudness for an approaching object and a decreasing loudness for a departing object), but such a motion perception may be further refined by considering time modifications creating across channel time delays connected with a realistic motion of an audio source. Particularly, the acoustic Doppler effect does not only modify the loudness of a departing or approaching sound source, but also frequency, tempo and other time-related audio parameters. By considering such time-related properties, the movement of the played back audio data will be perceived to be significantly more natural as compared to a simple loudness regulation system, or more precisely is closer to the perception of a moving sound source.

Such a motion experience generation unit may be adapted for generating an audible experience that an audio source reproducing the first audio item is departing during an end portion of the first audio item. Thus, the manipulation of the corresponding audio item portion may be performed in such a manner that an acoustic Doppler effect of a departing sound source is simulated.

The motion experience generation unit may further be adapted for processing the second audio item in a manner to generate an audible experience that an audio source reproducing the second audio item is moving during the transition portion, particularly is approaching during a beginning portion of the second audio data. In other words, in such embodiments, the processing of the beginning portion of the second audio item may be performed in such a manner that an impression of an acoustic Doppler effect of an approaching audio source can be perceived by a human ear.

It is very intuitive, from a psychological point of view, that fading out is correlated with a departing sound source, and fading in is correlated with an approaching sound source.

The motion experience generation unit may be adapted for generating a transition between an end portion of the first audio item and a beginning portion of the second audio item in accordance with the following sequence of measures. First, a first portion of the transition portion of the second audio item may be processed so that a reproduction of the transition portion of the second audio item is perceivable as originating from a remote start position. In other words, the second audio item is switched on and will be perceived as coming from a sound source which is located far away, which can be simulated by a small volume and a corresponding directional property. Subsequently, a first portion of the transition portion of the first audio item may be processed in such a manner that a reproduction of the transition portion of the first audio item is perceivable as originating from a position being shifted from a central position to a remote final position. In other words, during playback of a central portion of the first audio item, this audio data may be configured in such a manner that a human listener has the impression that the sound source emitting the first audio item is located at a central position. In order to indicate that the first audio item will be faded out subsequently, it is possible to virtually move the sound source emitting the first audio item in the first portion of the transition portion from this central position to a remote final position. This motion may be performed gradually. Simultaneously, with this departure of the virtual sound source emitting the first audio item, a second transition portion of the second audio item may be processed in such a manner that a reproduction of the second portion of the transition portion of the second audio item is perceivable as originating from a position being shifted (for instance gradually) from the remote start position to a central position (the same position at which the (virtual) sound source emitting the first audio item had been positioned beforehand, or another position). Therefore, since the second audio item shall be faded in, the human listener will get the impression that the virtual audio source emitting acoustic waves indicative of the second audio item is approaching to a position at which the main part of the second audio item will be reproduced. Subsequently, a third part of the transition portion of the first audio item is processed so that the transition portion of the first audio item is muted. Therefore, after the second audio item has (virtually) approached a final or intermediate position, the volume of the first audio item may be reduced (gradually or in a stepwise manner), so that the fade out procedure is finished. Optionally, the virtual sound source emitting the main portion of the second audio item may then be repositioned again, or may be maintained at the central position.

The “central position” may refer to the way how headphone signals are generated from the original audio signals during the “central portion” of the audio. For example, when no transition is being done, the left signal goes unprocessed to the left ear and the right signal to the right ear. In the “central portion” of an audio track, a processing model may be used which may be denoted as the “central position (rendering/reproduction/)”. In the central position, the signals representing the original left and right audio channels (of a stereo signal) may be typically directly routed to the left and right headphones, or the some processing is applied to the signal which is not related to the processing during the transition. This type of additional processing may be related to spectrum equalization, spatial widening, dynamic compression, multichannel-to-stereo conversion in case where the original audio data has other than stereo format, or other types of audio processing effects and enhancement applied during the central portion of audio tracks independently of the transition method used during the transition portions.

The device may comprise an audio reproduction unit adapted for reproducing the processed audio data. Such a (physical or real) audio reproduction unit may be, for instance, headphones, earphones or loudspeakers, which may be supplied with the processed audio data for playback. The audio data may be processed in such a manner that a user listening to the played back audio data gets the impression that the (virtual) audio reproduction units are located at another location.

The first audio item may be a music item (for instance a music clip or a music track on a CD), a speech item (for instance a portion of a telephony conversation), or may be a video/an audiovisual item (such as a music video, a movie, etc.). Thus, embodiments of the invention may be implemented in all fields in which audio data have to be processed, particularly in which two audio items shall be connected to one another in a smooth manner.

Exemplary fields of application of exemplary embodiments of the invention are automatic disc jockey systems, systems for searching audio items in a play list, a broadcasting channel switch system, a public Internet page switch system, a telephony channel switch system, an audio item playback start system, and an audio item playback stop system. A system for searching audio items in a play list may allow to search or scan a play list for specific audio items and to subsequently play back such audio items. At transition portions between two subsequent such audio items, embodiments of the invention may be implemented. Furthermore, when switching between different television or radio channels, that is to say in a broadcasting channel switch system, fade out of the previous channel and fade in of the subsequent channel may be performed according to exemplary embodiments of the invention. The same holds when a user operating a computer switches between different Internet pages, thereby using a public Internet page switch system. When, during a telephony conversation, a switch between different channels or communicating partners may be performed, embodiments of the invention may be implemented for such a telephony channel switch system. Also for simply starting or stopping audio playback, that is to say for changing between a mute and a loud playback mode, embodiments of the invention may be implemented.

Embodiments of the invention may be combined with the additional possibility to use spatial transition effects to create an illusion of a spatial separation between two songs. The two songs that are “cross-faded” may have different movement trajectories such that the existing source (first song) moves away to the for instance left side, whereas the new song (second source) moves into the sound image from the right.

The use of ascending and descending harmonic patterns in making the two items separate may have also a strong support from experimental psychology where it has been observed that difficult frequency modulation trajectories of two tone complexes causes the two tone complexes to separate in two different perceptual streams (see for instance A. S. Bregman (1990), “Auditory Scheme Analysis: The Perceptual Organization of Sound”, Cambridge, Mass.: Bradford Books, MIT Press).

The effect of a manipulation of timing-related audio parameters is that the songs are perceptually decoupled in a mixing region such that they are not perceived as incompatible anymore. Therefore, using this method, low special care needs to be taken to make sure that tempo, rhythm or harmony matches. This allows for the mixing of any arbitrary pair of songs, and thus for any play list that needs to be played back by the auto DJ method according to an exemplary embodiment of the invention.

Exemplary embodiments of the invention may be applied in applications where song transitions are created by mixing the beginning and end of two consecutive songs to get a smooth transition such as for example in an automatic DJ application.

According to another exemplary embodiment of the invention, a spatial transition between transition effect and normal listening may be made possible. Spatial transition effects may be used in forced transitions between audio items. The transition effects are based on dynamic specialisation of audio streams typically in a model-based rendering scenario. It is not desired to run model-based spatial processing in normal headphone listening and therefore, the transitions may be defined for normal listening to the transition rendering, and back.

Thus, moving from one track to another may be performed using spatial manipulation of audio signals. A goal may be to give a perception that one track goes physically away and another track comes in. For example, in such a way that the current music track flies far away to the right-hand side and another track slides in from the left-hand side. When this is performed in the context of an audio player list, it gives a very strong spatial impression on the play list. This type of representation of audio play list items in spatial coordinates may offer new applications in audio technology.

In headphone listening, it is clearly defined what is left and what is right. An obvious solution is to use, for example, standard amplitude panning rules to change a balanced stereo image in such a way that it gradually attenuates and moves to the right ear signal only, and simultaneously increase the volume of another track starting from the left ear. However, the transition effect obtained in this way is not very interesting nor does it give a very strong spatial impression of the track change. An issue may be that the two channels of a stereo audio recording may contain very different types of auditory cues depending on the production of the recording.

Usually, the two channels of a stereo audio item are correlated. However, the correlation, for example created in amplitude panning or a stereo reverberation, has no direct relation to any identifiable spatial attributes such as distances of audio sources, or unambiguous angles of arrival of sounds of, for instance, individual music instruments. Therefore, a challenge in creating convincing spatial audio track changes is that it may be inappropriate to just throw an audio track somewhere far out to the right because it has no spatial location in the first place. Such challenges may be met by using a rendering scenario based on virtual loudspeaker listener systems. However, it is also possible to consider transitions between a normal listening scenario (in headphones, or stereo or multi-channel loudspeaker reproduction) and a track transition effect.

Next, an embodiment will be explained which relates to spatial transitions between audio items. A method may be provided for implementing intuitive spatial audio effects in forced transitions from one audio stream to another in headphone listening. The proposed effect provides a new spatial dimension to the listening experience, for instance when a user presses a “next” or a “previous” button in going through a play list, or is browsing through a list of radio channels. The method is based on mapping the stereo signal to a virtual loudspeaker listener model where spatial transitions can be made intuitive and clear.

A way of moving from one track to another using spatial manipulation of audio signals may be provided to give a perception that one track goes physically away and the other one comes in. For example, in such a way that the current music track departs to a first direction and another track slides in from a second direction which may be opposite to the first direction. When this is performed in the context of an audio play list, it gives a very strong spatial impression of the play list. For example, a user may remember that a first song is right on the left-hand side of a second song and another song is somewhere far to the right. Naturally, the scenario can be directly extended to directions such as North, East, South and West to give a user a two-dimensional representation of audio material. Therefore, one-dimensional, two-dimensional or even three-dimensional spatial effects may be made possible. Thus, it is possible to position two audio channels of stereo audio material to a simulated loudspeaker listener scenario where the loudspeaker and the listener's ears have well-defined geometric positions. Once this is done, it is possible to move the virtual loudspeakers to arbitrary positions to create the desired spatial effects. In swapping from one audio item to another, the simulation can be performed such that two virtual loudspeakers playing a first audio item are moved far to the left from the user's ears and another pair of loudspeakers playing another item are carried in from the right to an appropriate or optimal playback position. Thus, it is possible to provide a geometric characterization of different spatial audio listening scenarios, and simulations of sound propagations in a virtual acoustic environment may be used.

When an audio item has to end and another one has to begin, the aural image of the first audio item moving away from the listener in one direction and a second audio item moving towards the listener is created. A method of transitioning audio during forced transitions and headphone listening may be provided. The method may comprise starting a new item at a certain position by simulating a virtual loudspeaker, moving the present item from the headphones to a virtual loudspeaker configuration, moving the present item to a target position and simultaneously moving the loudspeaker position of the new item to the virtual loudspeaker position, moving the new item from the loudspeaker position to headphone listening, and muting the present item.

It is further possible to use the method, while previewing items on a play list so that the items pass (virtually) in front of the listener or while temporarily muting an item.

The device for processing audio data may be realized as at least one of the group consisting of an audio surround system, a mobile phone, a headset, a loudspeaker, a hearing aid, a television device, a video recorder, a monitor, a gaming device, a laptop, an audio player, a DVD player, a CD player, a harddisk-based media player, an internet radio device, a public entertainment device, an MP3 player, a hi-fi system, a vehicle entertainment device, a car entertainment device, a medical communication system, a body-worn device, a speech communication device, a home cinema system, a home theatre system, a flat television, an ambiance creation device, a subwoofer, and a music hall system. Other applications are possible as well.

However, although the system according to an embodiment of the invention primarily intends to improve the quality of sound or audio data, it is also possible to apply the system for a combination of audio data and visual data. For instance, an embodiment of the invention may be implemented in audiovisual applications like a video player or a home cinema system in which a transition between different audiovisual items (such as music clips or video sequences) takes place.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 illustrates an audio data processing device according to an exemplary embodiment of the invention.

FIG. 2 to FIG. 5 illustrate a transition to and from a transition model performed by parametric manipulation of the sound rendering based on the transition model according to an exemplary embodiment of the invention.

FIG. 6 illustrates a geometric description of a generic headphone listening as a special case of a loudspeaker listener model.

FIG. 7 illustrates a simulation of a listener in a two-channel loudspeaker listening configuration.

FIG. 8 shows a loudspeaker pair representing one audio track transferred away from the virtual microphone pair, and a new pair of loudspeakers playing another track is moved to the listening position.

FIG. 9 illustrates track transition in stereophonic loudspeaker listening according to an exemplary embodiment of the invention.

### DESCRIPTION OF EMBODIMENTS

The illustration in the drawing is schematically. In different drawings, similar or identical elements are provided with the same reference signs.

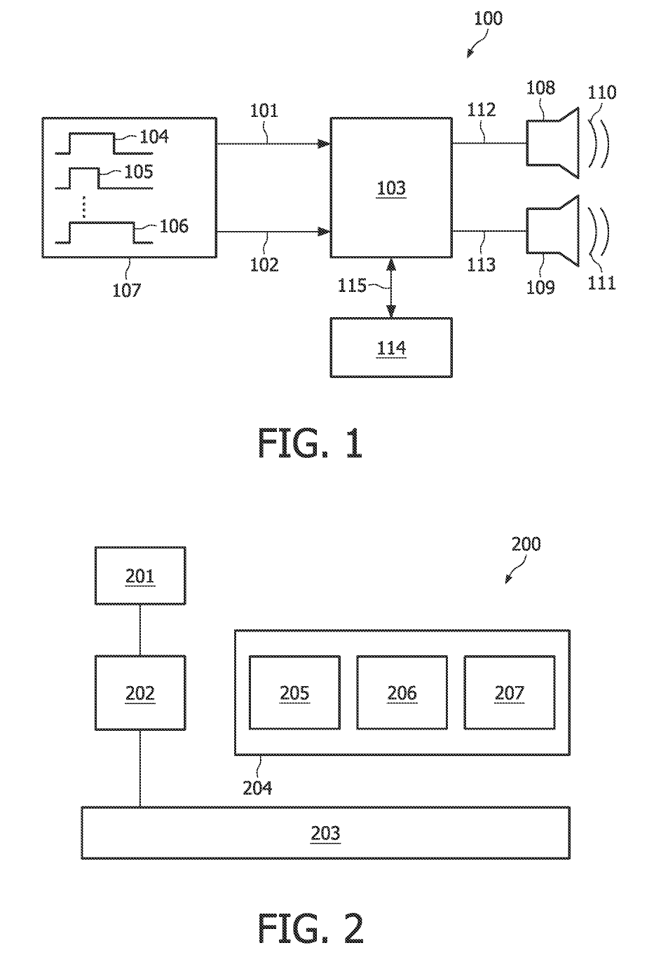

In the following, referring to FIG. 1, a device 100 for processing audio data 101, 102 according to an exemplary embodiment of the invention will be explained.

The device 100 shown in FIG. 1 comprises an audio data source 107 such as a CD, a harddisk, etc. On the audio data source 107, a plurality of music tracks are stored, such as a first audio item 104, a second audio item 105 and a third audio item 106 (for instance three music pieces).

Upon receipt of a corresponding control signal, audio data 101, 102 (for instance data for a left and for a right loudspeaker) may be transmitted from the audio data source 107 to a control unit 103 such as a microprocessor or a central processing unit (CPU).

The control unit 103 is in bidirectional communication with a user interface unit 114 and can exchange signals 115 with the user interface unit 114. The user interface unit 114 comprises a display element such as an LCD display or a plasma device, and comprises an input element such as a button, a keypad, a joystick or even a microphone of a voice recognition system. A human user can control operation of the control unit 103 and may therefore adjust user preferences of the device 100. For instance, a human user may switch through items of a play list. Furthermore, the control unit 103 can output corresponding playback or processed information.

After having processed the audio data 101, 102 in a manner which will be described below in more detail, a first processed audio data 112 is applied to a first loudspeaker 108 for playback, to thereby generate acoustic waves 110, a second processed audio data 113 is obtained which may be reproduced by a connected second loudspeaker 109, capable of generating acoustic waves 111.

In a scenario, in which the first audio item 104 shall be reproduced, and subsequently the second audio item 105 shall be reproduced, it may be desirable to have a smooth or seamless transition portion between the previous first audio item 104 and the subsequent second audio item 105. For this purpose, the control unit 103 may serve as a manipulation unit for manipulating a transition portion between the first audio item 104 and the second audio item 105 in a manner that a time-related audio property of the transition portion is modified. More particularly, an end portion of the first audio item 104 and a starting portion or beginning portion of the second audio item 105 may be processed. Therefore, an audible perception may be obtained that the first audio item 104 glides out or fades out, and the second audio item 105 glides in or fades in. For this purpose, the time properties of the first and second audio items 104, 105 may be adjusted only in the transition portion, whereas a central portion of the first and second audio items 104, 105 may be played back without modifications. This may include modifying frequency and tempo values of the audio data 101, 102 so that the gliding out first audio item 104 will be manipulated in accordance with the acoustic Doppler effect so that a perception of the manipulated first audio item 104 for a human listener is that both volume and frequency/tempo are reduced in the end portion.

Accordingly, the starting portion of the second audio item 105 is manipulated in accordance with the acoustic Doppler effect so that the perceived audible effect of the beginning portion of the second audio item 105 is that of an increased loudness and an increased frequency/tempo. By taking this measure, a very intuitive fading in characteristic may be obtained.

The manipulated end portion of the first audio item 104 and the manipulated beginning portion of the second audio item 105 may be played back simultaneously or in an overlapping manner.

The variation of the time characteristics of the end portion of the first audio item 104 and of the beginning portion of the second audio item 105 are harmonized or coordinated so as to achieve an appropriate sound.

Particularly, the control unit 103 may also generate the perception that a virtual audio source emitting the acoustic waves in accordance with the end portion of the first audio item 104 departs during playing back an end portion of the first audio item 104. More particularly, such a motion experiment generation feature may generate the audible perception that a virtual playback device playing back a beginning portion of the second audio item 105 approaches the human listener.

The system of FIG. 1 can be used as an automatic DJ system.

Embodiments of the invention are based on the insight that any spatial transition effect is either implicitly or explicitly based on a model of a loudspeaker-listener system. The model may be used to control the dynamic rendering operations achieved by digital filtering of original audio signals of the audio works. In a normal listening scenario, the audio signals may be played back directly through the loudspeakers of the reproduction system. According to an exemplary embodiment, the loudspeaker system may be any configuration ranging from stereophonic headphones to a multi-channel loudspeaker system such as a 5.1 surround audio system or a wave field synthesis system.

According to an exemplary embodiment, a generic approach is provided for the transition from normal listening to the rendering model used in spatial track transition effect and the reversed transition back to the normal listening mode. In such an embodiment, it is possible that the normal listening scenario can usually be identified as a special case of the rendering model used in the spatial transition effect. Therefore, the transition to and from the transition model can be performed by a parametric manipulation of the sound rendering based on a transition model. This is illustrated in FIG. 2 to FIG. 5 and will be described below in more detail.

FIG. 2 shows a scheme 200.

The scheme 200 shows an audio work 201 which is played back in an audio reproduction path in normal listening 202. An audio reproduction system is denoted with reference numeral 203 and may be realized as headphones, a stereo system, or a 5.1 system.

Furthermore, a virtual loudspeaker-listener model is indicated with reference numeral 204 and includes a special case of a model representing normal listening 205, an audio reproduction path of a transition effect 206, and an other audio reproduction path of the transition effect 207.

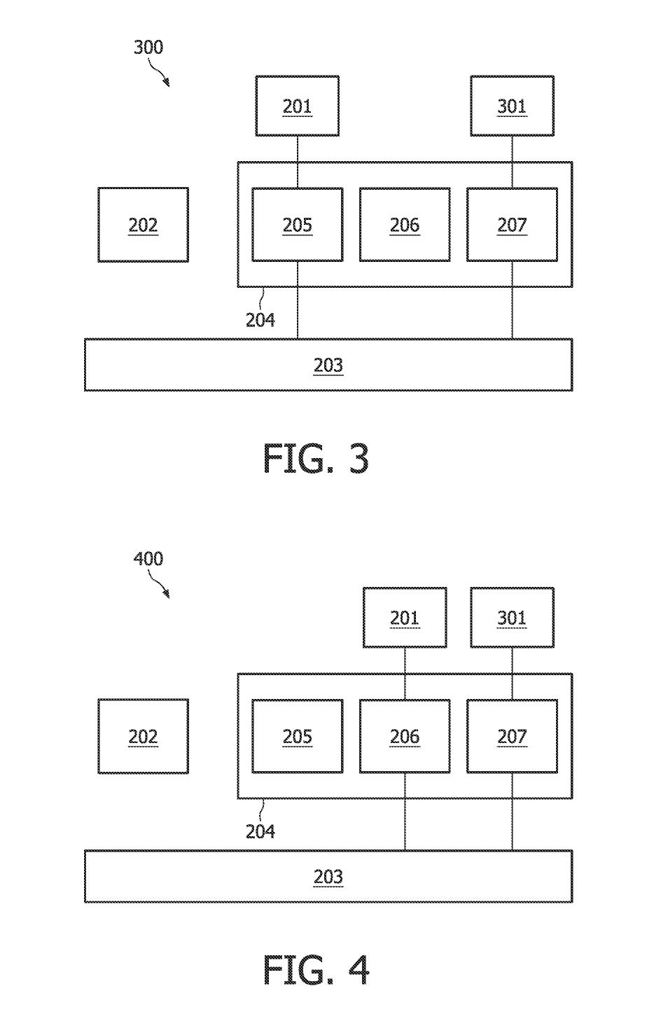

FIG. 3 shows a scheme 300. In the scheme 300, a second audio work 301 is shown as well.

As can be taken from FIG. 3, in the start of the transition, the first audio work 201 is routed through the special case of a model representing normal listening 205 of the transition model. The transition from the special case of a model representing normal listening 205 to the audio reproduction path of a transition effect 206 starts and it is based on parametric manipulation of the parameters of the virtual loudspeaker-listener model 204. The dynamic transition rendering of the second audio work 301 may start in this phase, through the other audio reproduction path of the transition effect 207.

FIG. 4 shows a scheme 400 at a later time.

In a continuous transition, both the first audio work 201 and the second audio work 301 are rendered using the virtual loudspeaker-listener model 204 to achieve the desired dynamic spatial transition effects. Typically, the first audio work 201 is reproduced in such a way that it appears going away from the listener, whereas the second audio work 301 is approaching the listener.

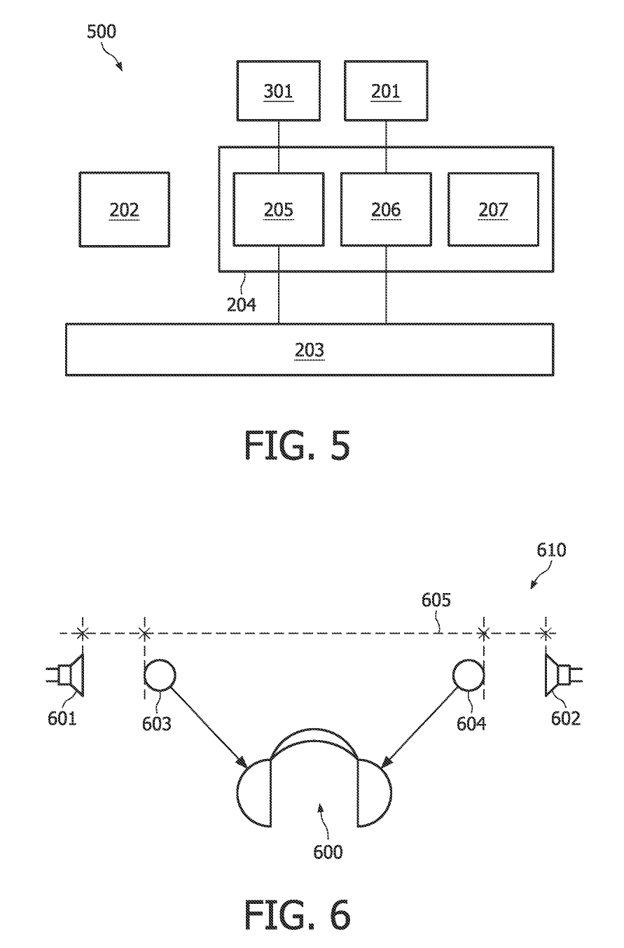

A subsequent scheme 500 is shown in FIG. 5.

Referring to FIG. 5, the dynamic rendering of the second audio work 301 is modified in such a way that it ends up equivalent mode representing the normal listening scenario. In other words, the second audio work 301 is shifted from the audio reproduction path of the transition effect 207 to the special case of a model representing normal listening 205. Finally, the reproduction from the special mode of the virtual loudspeaker listener rendering scenario is switched to the normal audio reproduction scenario of FIG. 2 for the second audio work 301.

According to an exemplary embodiment of the invention, it is possible to use a model where a signal x(n) played from a virtual loudspeaker is captured using a virtual microphone such that the captured signal is given by

y(n)=x(n)*δ(dT)/d²

wherein the asterisk denotes convolution, d is the distance between a virtual loudspeaker and a microphone in meters and T=F/c, wherein F is the sampling frequency and c is the speed of sound. In practice, signal values corresponding to fractional time indices dT can be implemented using fractional delay filters such as the Lagrange interpolator filter.

FIG. 6 shows an array 610 relating to a geometric description of a generic headphone listening as a special case of a loudspeaker-listener model.

FIG. 6 shows headphones 600 for reproducing audio content. Furthermore, a left virtual loudspeaker 601 and a right virtual loudspeaker 602 are shown. Furthermore, a left virtual microphone 603 and a right virtual microphone 604 are shown. An infinite distance is denoted with reference numeral 605.

Based on the previous discussion, the correlations, or the crosstalk between stereo channels can be seen coincidental such that the correlation between signals in the geometric acoustic sense is not modelled as a leakage of the sound from one audio channel to another.

The normal listening mode in an embodiment of the invention is the headphone listening. A geometric description of such a generic headphone audio listening scenario in accordance with the array 610 as a special case of the presented loudspeaker-listener model is illustrated in FIG. 6. The sound is played from the left and right virtual loudspeakers 601, 602 that, in principle, are placed infinitely far away from each other. The sound is captured by the left and right virtual microphones 603, 604 placed close to the left and right virtual loudspeakers 601, 602. The captured signals are then played back to the user through the headphones 600. Synthesis of a stereophonic recording from original left and right channels produces the original signals exactly in the headphone listening. The infinite distance of this geometric description is only one embodiment to model the lack of crosstalk between the two signals, a similar result can be obtained by giving microphones (or loudspeakers, or both) directivity properties that reduce or cancel the crosstalk.

According to an exemplary embodiment, only omnidirectional virtual speakers and microphones in free field are considered. However, embodiments of the invention also contain the use of directivity and sound field simulations. Measures needed to include more realistic directivity properties and room models into an acoustic model are known by the skilled person. In practice, it is not necessary or possible, to have an infinite distance between the sources even with omnidirectional transducers. The attenuation of sound in decibels in free field conditions and for an omnidirectional source is given by

L_{R}=20 log₁₀(R)

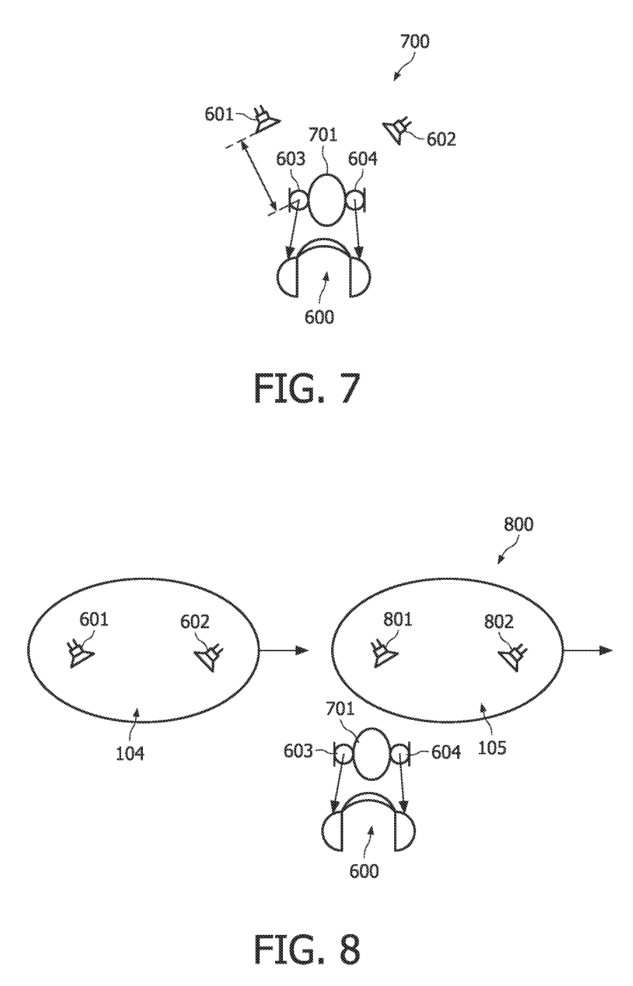

For example, a separation of 20 meters already gives a crosstalk attenuation of 26 dB which may have a negligible effect on the spatial image in a typical stereo audio material. Such a representation is perceptually similar to original stereo reproduction and does also not provide immediately intuitive special track transition methods. However, it is possible to make another transformation which moves the left and right virtual loudspeakers 601, 602 and the left and right virtual microphones 603, 604 positions to another setup 700 illustrated in FIG. 7, additionally showing a head 701 of a human listener.

In FIG. 7, the left and right virtual loudspeakers 601, 602 are moved to the positions of left and right loudspeakers in a typical loudspeaker listening. The left and right virtual microphones 603, 604 are moved to positions representing positions of listener's ears in a typical listening situation.

Thus, FIG. 7 shows a simulation of a head 701 of a listener in a two-channel loudspeaker listening system.

The distance between the left virtual loudspeaker 601 and the left virtual microphone 603 is kept constant in the transition from the scenario of FIG. 6 to the scenario of FIG. 7. Therefore, the overall loudness of the stereo audio reproduction is kept approximately the same. However, a characteristic is not absolutely necessary for the current embodiment.

FIG. 8 schematically shows a scheme 800 including a first audio item 104 and a second audio item 105 of audio data to be played back.

The pair of left and right virtual loudspeakers 601, 602 representing the first audio item 104 may be transferred away from the pair of left and right virtual microphones 603, 604, and a new pair of loudspeakers 801, 802 related to the second audio item 105 is moved to the listening position.

In a typical application, the jump from one audio item A to an audio item B may take the following procedure. The sequence may start from a situation where a user is listening to item A.

1. Place loudspeaker set of item B to the start position. The start position may be, for instance, a location far on the right from the user's ear.
2. Move item A from headphone listening (FIG. 6) to loudspeaker listening (FIG. 7) and place the virtual loudspeakers to the listening position.
3. Move item A to a target position (for instance somewhere far to the left from the user's ears) and simultaneously move item B from the start position to the listening position.
4. Move loudspeakers representing item B from loudspeaker simulation to the headphone simulating configurations.
5. Mute item A.
A similar algorithm can also be used in fast scanning or search of audio items in a play list. In this case, a sequence of audio item flows from right to the left (or vice versa) to give a user an overview (preview) of the content of the play list, or help to identify a particular item. In this particular application, it may be useful to emit the headphone listening simulation such that items are played back in the loudspeaker playback configuration. This alternative provides a smooth flow of audio items past the listener. In this type of scenario, a play list can also be represented as a two- or three-dimensional map where the user is free to navigate in the directions of left/right, forward/backward, up/down, or a combination thereof.

A similar embodiment can also be directly applied to other possible applications involving transitions between different audio streams. For example, in changing radio or TV channels, Internet pages with the background audio, changing from one audio application to another in a personal computer, etc.

A similar scenario can also be used to create new types of effects for transitions involving only one item. For example, a spatial transition effect can be used as starting and stopping the playback of an audio item, or in muting temporarily an audio item.

Furthermore, the same mechanism for spatial transitions can also be used in various different telephony applications to switch between different talkers.

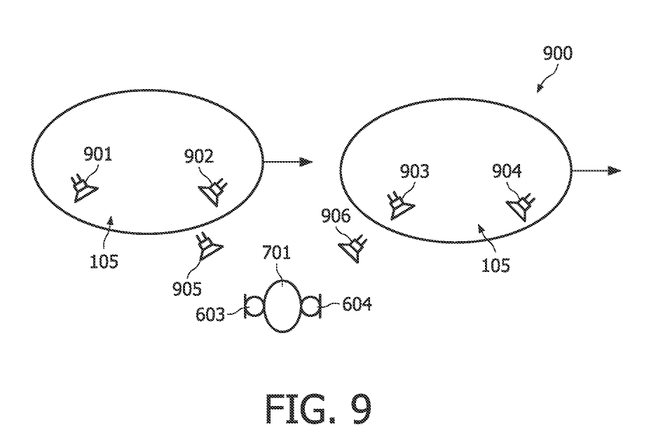

In another embodiment, the reproduction system may be a stereophonic loudspeaker system 900 as illustrated in FIG. 9.

FIG. 9 shows virtual loudspeakers 901, 902 playing back a second audio item 105, and virtual loudspeakers 903, 904 playing back the second audio item 105. Furthermore, left and right additional loudspeakers 905, 906 are shown. FIG. 9 therefore shows a track transition in stereophonic loudspeaker listening. The virtual loudspeakers 901 to 904 are created by processing the audio signals feeding the left and right additional loudspeakers 905, 906 using anyone of 3D audio rendering techniques which are known, as such, to those skilled in the art.

In the scenario of FIG. 9, the transition to the normal audio listening where signals are played directly through the left and the right additional loudspeaker 905, 906 is obtained by moving the “bubble” containing the virtual loudspeakers 901 to 904 in such a way that the positions and the directional properties of the rendered virtual loudspeakers coincide with the real loudspeakers.

In terms of processing, it is possible to give the following description for the transition from the playback of the second audio item 105 through the virtual loudspeaker listener system to the playback through the true left and right additional loudspeakers 905, 906 of the stereo setup. The dynamic rendering algorithm is based on linear digital filtering of the input signals which may be described by the following different equations:

y(n)ₗ=x(n)ₗ*h(n,t)ₗₗ+x(n)ᵣ*h(n,t)ᵣₗ

y(n)ᵣ=x(n)ₗ*h(n,t)ᵣₗ+x(n)ᵣ*h(n,t)ᵣᵣ

where the asterisk represents convolution and the rendering filters are represented by the impulse responses. One special case of this rendering model is where the direct left to left (ll) and right to right (rr) filters are reduced to unity gains and the crosstalk terms (left to right (lr) and right to left (rl)) vanishes. This special case is identical to the normal listening with loudspeakers. In dynamic rendering, the transition can therefore be achieved from any spatial rendering scenario by using a dynamic transition path implementing the smooth evolution of the coefficients from the original rendering filters to the functions representing a special case.

It should be noted that the term “comprising” does not exclude other elements or features and the “a” or “an” does not exclude a plurality. Also elements described in association with different embodiments may be combined.

It should also be noted that reference signs in the claims shall not be construed as limiting the scope of the claims.

1. A device (100) for processing audio data (101, 102), wherein the device (100) comprises a manipulation unit (103) adapted for manipulating a transition portion of a first audio item (104) of the audio data (101, 102) in a manner that a time-related audio property of the first audio item (104) of the audio data (101, 102) is modified selectively in the transition portion.

2. The device (100) according to claim 1, wherein the transition portion of the first audio item (104) is an end portion of the first audio item (104).

3. The device (100) according to claim 2, wherein the manipulation unit (103) is adapted for manipulating the end portion of the first audio item (104) in a manner that at least one of the group consisting of a tempo, a pitch, and a frequency of the manipulated end portion of the first audio item (104) is reduced.

4. The device (100) according to claim 1, wherein the manipulation unit (103) is adapted for manipulating a transition portion of a second audio item (105) of the audio data (101, 102) in a manner that a time-related audio property of the second audio item (105) of the audio data (101, 102) is modified selectively in the transition portion.

5. The device (100) according to claim 4, wherein the transition portion of the second audio item (105) is a beginning portion of the second audio item (105).

6. The device (100) according to claim 5, wherein the manipulation unit (103) is adapted for manipulating the beginning portion of the second audio item (105) in a manner that at least one of the group consisting of a tempo and a frequency of the manipulated beginning portion of the second audio item (105) is increased.

7. The device (100) according to claim 1, wherein the manipulation unit (103) is adapted for manipulating exclusively the transition portion or transition portions of the first audio item (104), whereas a remaining portion of the first audio item (104) remains free of a manipulation.

8. The device (100) according to claim 4, wherein the manipulation unit (103) is adapted for manipulating the transition portion of the first audio item (104) and the transition portion of the second audio item (105) in a coordinated manner for reproducing the first audio item (104) and subsequently the second audio item (105).

9. The device (100) according to claim 1, wherein the manipulation unit (103) is adapted for processing the first audio item (104) in a manner to generate an audible experience that an audio source reproducing the first audio item (104) is moving during the transition portion.

10. The device (100) according to claim 9, wherein the manipulation unit (103) is adapted for generating an audible experience that an audio source reproducing the first audio item (104) is departing during an'end portion of the first audio item (104).

11. The device (100) according to claim 4, wherein the manipulation unit (103) is adapted for processing the second audio item (105) in a manner to generate an audible experience that an audio source reproducing the second audio item (105) is moving during the transition portion.

12. The device (100) according to claim 11, wherein the manipulation unit (103) is adapted for generating an audible experience that an audio source reproducing the second audio item (105) is approaching during a beginning portion of the second audio item (105).

13. The device (100) according to claim 11, wherein the manipulation unit (103) is adapted for generating a transition between an end portion of the first audio item (104) and a beginning portion of the second audio item (105) in accordance with the following sequence:
processing the transition portion of the second audio item (105) so that a reproduction of the transition portion of the second audio item (105) is perceivable as originating from a remote start position;
processing the transition portion of the first audio item (104) so that a reproduction of the transition portion of the first audio item (104) is perceivable as originating from a position being shifted from a central position to a remote final position;
simultaneously with processing the transition portion of the first audio item (104), processing the transition portion of the second audio item (105) so that a reproduction of the transition portion of the second audio item (105) is perceivable as originating from a position being shifted from the remote start position to the central position;
subsequently processing the transition portion of the first audio item (104) so that the transition portion of the first audio item (104) is muted.

14. The device (100) according to claim 1, wherein the manipulation unit (103) is adapted for manipulating the transition portion in a manner that the time-related audio property of the audio data (101, 102) is gradually modified within the transition portion.

15. The device (100) according to claim 1, wherein the manipulation unit (103) is adapted for manipulating the transition portion in a manner that the time-related audio property of the audio data (101, 102) is modified to generate an audible experience in accordance with the acoustic Doppler effect in the transition portion.

16. The device (100) according to claim 1, wherein the manipulation unit (103) is adapted for manipulating the transition portion in a manner to achieve a smooth connection between the transition portion and a central portion of the first audio item (104).

17. The device (100) according to claim 1, wherein the manipulation unit (103) is adapted for manipulating the transition portion of the first audio item (104) in a manner that additionally a loudness of the audio data (101, 102) is modified selectively in the transition portion.

18. The device (100) according to claim 1, wherein the manipulation unit (103) is adapted for manipulating the transition portion of the first audio item (104) in a manner that time delay audio properties of the audio data (101, 102) are modified selectively in the transition portion.

19. The device (100) according to claim 1, comprising an audio reproduction unit (108, 109), particularly one of the group consisting of headphones, earpieces, and loudspeakers, adapted for reproducing the processed audio data (112, 113).

20. The device (100) according to claim 1, wherein the first audio item (104) comprises at least one of the group consisting of a music item, a speech item, and an audiovisual item.

21. The device (100) according to claim 1, adapted for at least one of the group consisting of an automatic disc jockey system, a system for searching audio items in a play list, a broadcasting channel switch system, a public Internet page switch system, a telephony channel switch system, an audio item playback start system, and an audio item playback stop system.

22. The device (100) according to claim 1, realized as at least one of the group consisting of an audio surround system, a mobile phone, a headset, a headphone playback apparatus, a loudspeaker playback apparatus, a hearing aid, a television device, a video recorder, a monitor, a gaming device, a laptop, an audio player, a DVD player, a CD player, a harddisk-based media player, a radio device, an internet radio device, a public entertainment device, an MP3 player, a hi-fi system, a vehicle entertainment device, a car entertainment device, a medical communication system, a body-worn device, a speech communication device, a home cinema system, a home theatre system, a flat television apparatus, an ambiance creation device, a subwoofer, and a music hall system.

23. A method of processing audio data (101, 102), wherein the method comprises manipulating a transition portion of a first audio item (104) of the audio data (101, 102) in a manner that a time-related audio property of the first audio item (104) of the audio data (101, 102) is modified selectively in the transition portion.

24. A computer-readable medium, in which a computer program of processing audio data (101, 102) is stored, which computer program, when being executed by a processor (103), is adapted to carry out or control a method according to claim 23.

25. A program element of processing audio data (101, 102), which program element, when being executed by a processor (103), is adapted to carry out or control a method according to claim 23.
